(19) United States
(12) Patent Application Publication
(10) Pub. No.: US 2010/0061446 A1
(43) Pub. Date: Mar. 11, 2010

(54) VIDEO SIGNAL ENCODING

(76) Inventors: David S. Hands, Ipswich (GB); Andrew G. Davis, Woodbridge (GB); Damien R.R. Bayart, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/522,121

(22) PCT Filed: Jan. 3, 2008
(86) PCT No.: PCT/GB08/00010

§ 371 Date: Jul. 2, 2009

(30) Foreign Application Priority Data
Jan. 4, 2007 (EP) 07250029.1

(51) Int. Cl. H04N 7/32

(52) U.S. Cl. 375/240.02; 375/E07.126

(57) ABSTRACT

A method and system for encoding a video signal provides an encoded signal that is compressed in order that it may be efficiently transmitted over the link whilst also meeting a predetermined standard in terms of its estimated perceptual quality when the signal is decoded and displayed. This is achieved by providing, at the encoding end, a control unit (24) which utilises a perceptual quality metric (PQM) system (32) to quantify the estimated perceptual quality, and control logic (34) that compares said quantified PQM with a user-defined criterion that the signal must meet prior to transmission. The signal is preferably only transmitted onwards over the communications link if the criterion is met. Otherwise, the control unit (24) is operable either to modify the signal, e.g. using pre-filtering, or use modified encoding parameters to re-encode the signal in such a way as to improve its quality, that is to make the quantified PQM converge towards the criterion. A number of iterations of this encode-modify-encode sequence may be required before the resulting PQM meets the criterion and so be transmitted. The number of iterations may be limited in which case the modified encoding should at least provide an improvement in perceptual quality.

The present invention relates to a method and system for encoding a video signal representing a plurality of frames, and in particular to a method and system for encoding a video signal which derives a quality measure for the encoded signal.

It is known to encode a digital video signal so that it can be efficiently transmitted over a communications link. The source data is encoded in such a way as to reduce the amount of data that needs to be transmitted, for example using well-known techniques such as the prediction of blocks of pixels, discrete cosine transformation (DCT), quantisation, run-length encoding and other compression techniques utilising statistical and psychophysical redundancy. Well known video encoding algorithms/standards include MPEG-2 and H.264/MPEG-4 AVC and it will be appreciated that other known standards exist. At the decoding end of the communications link, software is provided for decoding, or decompressing, the encoded video so that it can be output to a display device.

Although useful in terms of reducing the amount of data to be transmitted over a data link, the process of compressing a video signal with a quantisation process (not noiseless encoding) will can introduce distortion and therefore reduce the quality of the video. Many encoding algorithms tend to exploit limitations in the human visual system (HVS) so that as little distortion as possible is perceived by the viewer. One way of measuring distortion involves noting the opinion of viewers as to the level of perceptible distortion in a decoded video sequence and averaging the results to obtain a Mean Opinion Score (MOS). However, this manual process can be time consuming and requires a trained person to properly judge the video representative subject sample in order to provide meaningful data. Accordingly, it is known to provide software tools, so-called perceptual quality metric (PQM) tools, which estimate perceptual quality. Such PQM tools are provided at the decoder-end of the communications link. Applicant's international Patent Application No. GB2006/004155 describes in detail an exemplary PQM tool.

In commercial video systems, for example Internet Protocol TV (IPTV) systems, perceptual quality is an important issue. The nature of the channel will require data compression at the encoder end. However, customers of the IPTV service provider expect a certain level of service in terms of video quality and so service providers are keen to ensure the transmitted video will meet customer expectations for a significant amount, if not all, of the transmit time.

In one sense, the invention provides a method of encoding a video signal representative of a plurality of frames, the method comprising: (a) encoding the video signal, or part thereof, using a compression algorithm utilising at least one encoding parameter; (b) generating a measure of quality for the encoded signal using a perceptual quality metric and identifying whether said quality measure meets a predefined quality criterion; (c) in the event that said quality measure fails to meet the predefined quality criterion, iteratively performing steps (a) to (e) using either a modified value for the at least one encoding parameter, or a modified version of the video signal, said modification being such as to cause a reduction in the difference between the quality criterion and the updated quality measure.

According to a first aspect of the present invention, there is provided a method of encoding a video signal representative of a plurality of frames, the method comprising: (a) encoding the video signal, or part thereof, using a compression algorithm utilising at least one encoding parameter; (b) generating a measure of quality for the encoded signal using a perceptual quality metric and identifying whether said quality measure meets a predefined quality criterion; (c) in the event that said quality measure fails to meet the predefined quality criterion, iteratively performing steps (a) to (c) using either a modified value for the at least one encoding parameter, or a modified version of the video signal, until the quality measure so generated meets the predefined quality criterion.

A perceptual quality metric is understood to mean a metric or model, arranged to objectively estimate or predict perceived video quality, i.e. the quality of the video as perceived by a human viewer. This means that the resulting measure of quality can be applied automatically and consistently to the video data.

The method provides iterative re-encoding of a video signal in the event that its associated quality measure does not meet a predefined quality criterion, the re-encoding employing either a modified value of at least one encoding parameter or a modified version of the video signal. In this way, a feedback arrangement is employed to ensure the encoded signal meets some form of quality requirement. Such a method may provide particular advantages for video content service providers wishing to ensure a minimal level of service to its customers, for example in commercial applications such as IPTV. It will be appreciated that, once the quality measure is identified as meeting the predefined quality criterion, step (c) is not required to be performed.

The method is preferably performed at the encoder end of a communications link and may further comprise transmitting the encoded signal to a video decoder over a communications link only when the quality measure meets the predefined quality criterion.

The amount of modification applied to the encoding parameter value or the video signal in step (c) may be a function of the value of the quality measure generated in step (b).

The method may be performed in respect of first and second signal portions, the second signal portion being encoded only when the quality measure in respect of the first signal portion meets the predefined quality criterion.

The quality measure is preferably a numerical value generated using a predetermined algorithm and wherein the quality measure meets the predefined quality criterion if its value is within a predefined range of values. The predefined range may be defined between first and second boundary values and wherein the modification applied results in a change in the quality measure value so that, in the or each subsequent iteration, it converges towards one of the boundary values.

The encoded signal may represent a plurality of separately identifiable groups of frames (GOF), wherein a quality measure is derivable in respect of each GOF, and wherein, in step (c), a modified value for the at least one encoding parameter, or a modified version of the video signal, is applied in respect of each GOF not meeting the predetermined quality criterion.

The method may further comprise providing a plurality of modification profiles, each defining an alternative modification method to be applied in step (c), and selecting one of said profiles in dependence on one or more selection rules. For example, a first modification profile is selected in the event that a predetermined number of consecutive GOF fail to meet the predefined quality criterion, said first profile being arranged, when applied, to re-encode a filtered version of the video signal corresponding to the GOF. The filtering may comprise reducing the number of bits required to encode each frame of the GOF. A second modification profile may be selected in the event that, within a segment comprising a predetermined number of GOF, only some GOF fail to meet the predefined quality criterion, said second profile being arranged, when applied, to re-encode the video signal corresponding to each failed GOF using a modified encoding parameter.

A further quality measure may be generated for each individual frame and wherein, where said further quality measure for a frame fails to meet the predefined quality criterion, intra-frame analysis is performed on said frame to determine which part of the frame requires modification.

The at least one encoding parameter referred to above may include the quantization step size, in which case step (c) comprises applying a modified value of quantization step size. Alternatively or additionally, the at least one encoding parameter may include the encoding bit rate, in which case step (c) comprises applying a modified value of the encoding bit rate.

According to a second aspect of the invention, there is provided a method of encoding a video signal representative of a plurality of frames, the method comprising: (a) encoding the video signal, or part thereof, using a compression algorithm utilising at least one encoding parameter; (b) generating a measure of quality for the encoded signal in the form of a numerical value and identifying whether said numerical value meets a predefined quality criterion, said quality criterion being defined by a range of numerical values having an upper bound and a lower bound; (c) in the event that said quality measure fails to meet the predefined quality criterion, modifying the at least one encoding parameter and iteratively repeating steps (a) to (e) until said value so generated falls within said range of values.

According to a third aspect of the invention, there is provided a method of encoding a video signal representative of a plurality of frames, the method comprising: (a) encoding the video signal, or part thereof, using a compression algorithm utilising at least one encoding parameter; (b) generating a measure of quality for the encoded signal using a perceptual quality metric and identifying whether said quality measure meets a predefined quality criterion; (c) in the event that said quality measure fails to meet the predefined quality criterion, selecting one of a plurality of modification profiles, and, depending on the modification profile selected, repeating steps (a) to (c) using either a modified value for the at least one encoding parameter, or a modified version of the video signal, until the quality measure so generated meets the predefined quality criterion, wherein a first modification profile is selected in the event that a segment of the video signal comprising a predetermined number of frames fails to meet the predefined quality criterion, said first profile being arranged, when applied, to re-encode a filtered version of the video segment, and wherein a second modification profile is selected in the event that only a subset of frames or groups of frames within a segment of the video signal comprising a predetermined number of frames fails to meet the predefined quality criterion, said second profile being arranged, when applied, to re-encode the video signal corresponding to each failed frame or groups of frames using a modified encoding parameter.

According to a fourth aspect of the invention, there is provided a method of encoding a video signal representative of a plurality of frames, the method comprising: (a) encoding the video signal, or part thereof, using a compression algorithm utilising at least one encoding parameter, the encoded signal representing a plurality of separately identifiable groups of frames (GOFs); (b) for a video segment comprising a plurality of GOFs, generating a measure of quality for each GOF using a perceptual quality metric; (c) identifying one or more GOFs within the video segment for which the quality measure is below a predefined quality level and modifying the at least one encoding parameter used in respect of the or each below-quality GOFs in order that the quality measure will meet or approach the predefined quality level when re-encoded; (d) identifying one or more GOFs within the same video segment for which the quality measure is above a predefined quality level and modifying the at least one encoding parameter used in respect of the or each above-quality GOFs in order that the quality measure will meet or approach the predefined quality level when re-encoded; and (e) re-encoding the video segment using the encoding parameters modified in (c) and (d).

There may also be provided a carrier medium for carrying processor code which when executed on a processor causes the processor to carry out the above-described method.

According to a fifth aspect of the invention, there is provided a video encoding system comprising: a video encoder arranged to encode a video signal representative of a plurality of frames using a compression algorithm utilising at least one encoding parameter; a controller for receiving the encoded signal from the video encoder and arranged to generate a measure of quality for the encoded signal, to identify whether said quality measure meets a predefined quality criterion and, in the event that said quality measure fails to meet the predefined quality criterion, to cause the video encoder to iteratively re-encode the video signal using either a modified value for the at least one encoding parameter, or a modified version of the video signal, until the quality measure so generated meets the predefined quality criterion.

The controller may be arranged to transmit the encoded Signal to a video decoder over a communications link only when the quality measure meets the predefined quality criterion. The controller may be arranged such that, in use, the amount of modification applied to the encoding parameter value or the video signal is a function of the value of the quality measure. The system may further comprise a buffer for receiving and storing a predetermined number of encoded frames from the video encoder, the buffer being arranged to transmit said encoded frames to the controller in response to a control signal from the controller indicative that the quality measure generated in respect of a previously-transmitted set of frames meets the predefined quality criterion. The quality measure generated at the controller can be a numerical value generated using a predetermined algorithm and wherein the quality measure meets the predefined quality criterion if its value is within a predefined range of values. The predefined range may be defined between first and second boundary values and the modification applied at the controller may result in a change in the quality measure value so that, in the or each subsequent iteration, it converges towards one of the boundary values. The encoded signal generated by the encoder may represent a plurality of separately identifiable groups of frames (GOF), and wherein the controller is arranged to generate a quality measure in respect of each GOF and to apply in respect of each GOF not meeting the predetermined quality criterion a modified value for the at least one encoding parameter, or a modified version of the video signal. The controller may provide a plurality of modification profiles, each defining an alternative modification method to be applied in step (c), and is arranged to select one of said profiles in dependence on one or more selection rules. The controller can be arranged in use to select a first modification profile in the event that a predetermined number of consecutive GOF fail to meet the predefined quality criterion, said first profile being configured, when applied by the controller, to re-encode a filtered version of the video signal corresponding to the GOF. The filtering can comprise reducing the number of bits required to encode each frame of the GOF. The controller can be arranged in use to select a second modification profile in the event that, within a segment comprising a predetermined number of GOF, only some GOF fail to meet the predefined quality criterion, said second profile being configured, when applied by the controller, to re-encode the video signal corresponding to each failed GOF using a modified encoding parameter. The controller may be arranged to generate a further quality measure for each individual frame and wherein, where said further quality measure for a frame fails to meet the predefined quality criterion, intra-frame analysis is performed on said frame to determine which part of the frame requires modification. The at least one encoding parameter can include the quantization step size, step (c) comprising applying a modified value of quantization step size. Alternatively, or additionally, the at least one encoding parameter can include the encoding bit rate, step (c) comprising applying a modified value of the encoding bit rate.

The invention will now be described, by way of example, with reference to the accompanying drawings in which:

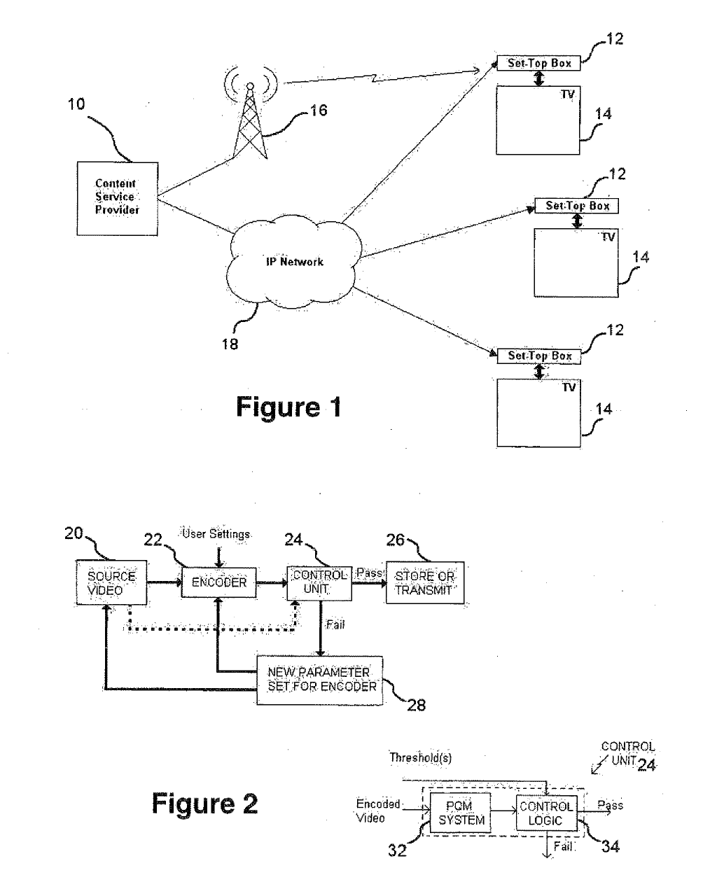

FIG. 1 is a block diagram of commercial video system in which an encoding system in accordance with the invention may be used at a content service provider end;

FIG. 2 is a block diagram of a generalised video encoding system according to the invention;

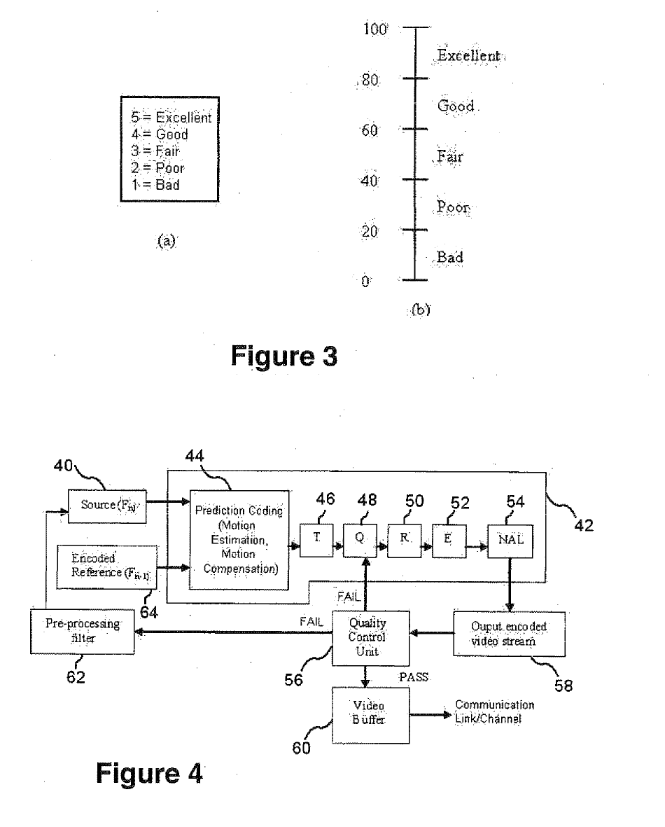

FIG. 3 shows alternative perceptual quality measurement scales which can be used to indicate, in numerical form, a quality measure for encoded video;

FIG. 4 is a block diagram of an H.264 video encoding system according to a preferred embodiment of the invention;

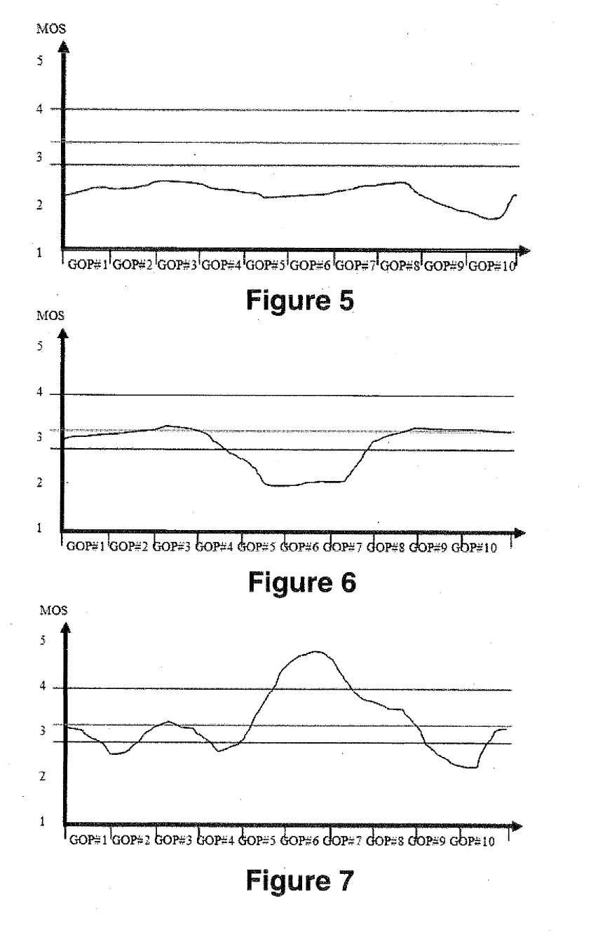

FIGS. 5, 6 and 7 are graphs showing example perceptual quality measures taken over a plurality of frames for three different quality scenarios;

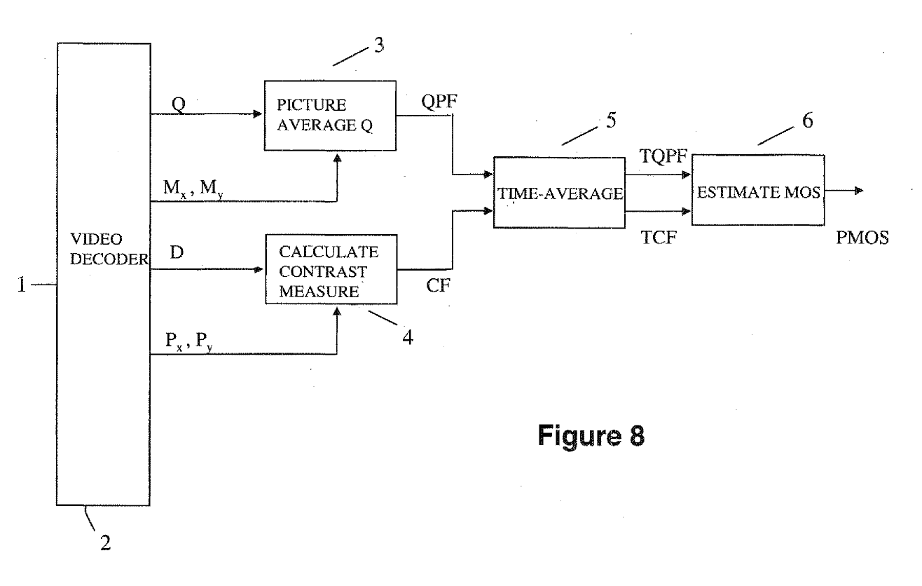

FIG. 8 is a block diagram showing in functional terms a perceptual quality measurement apparatus, suitable for use in the preferred embodiment, for estimating the quality of a video sequence;

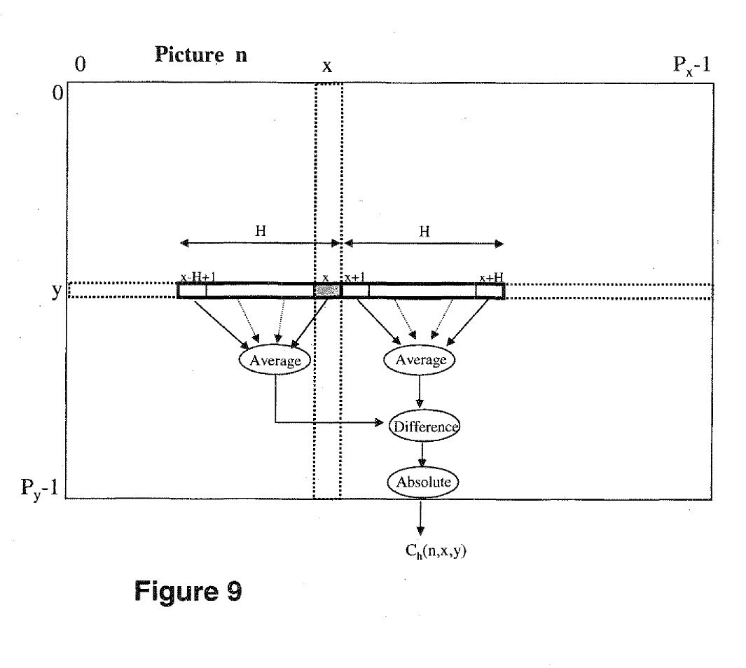

FIG. 9 illustrates how, in the apparatus of FIG. 8, a horizontal contrast measure is calculated for a pixel in a picture;

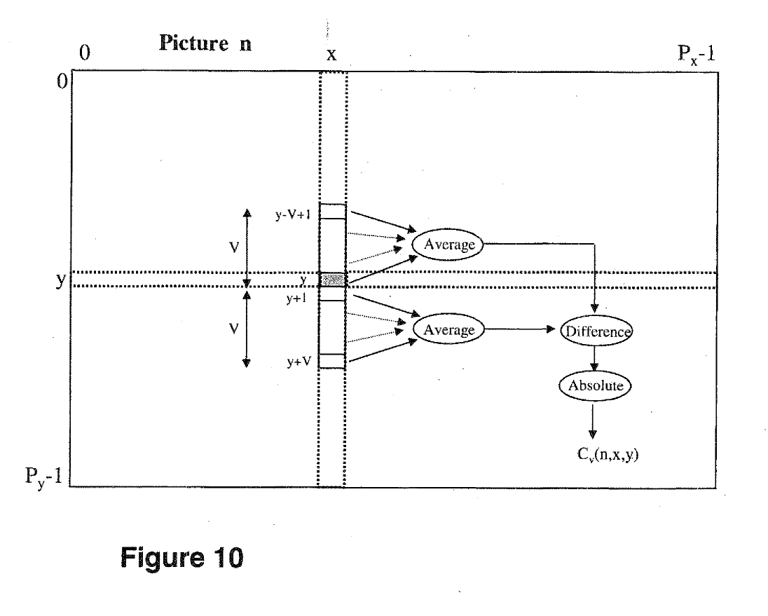

FIG. 10 illustrates how, in the apparatus of FIG. 8, a vertical contrast measure is calculated for the pixel in the picture of FIG. 9;

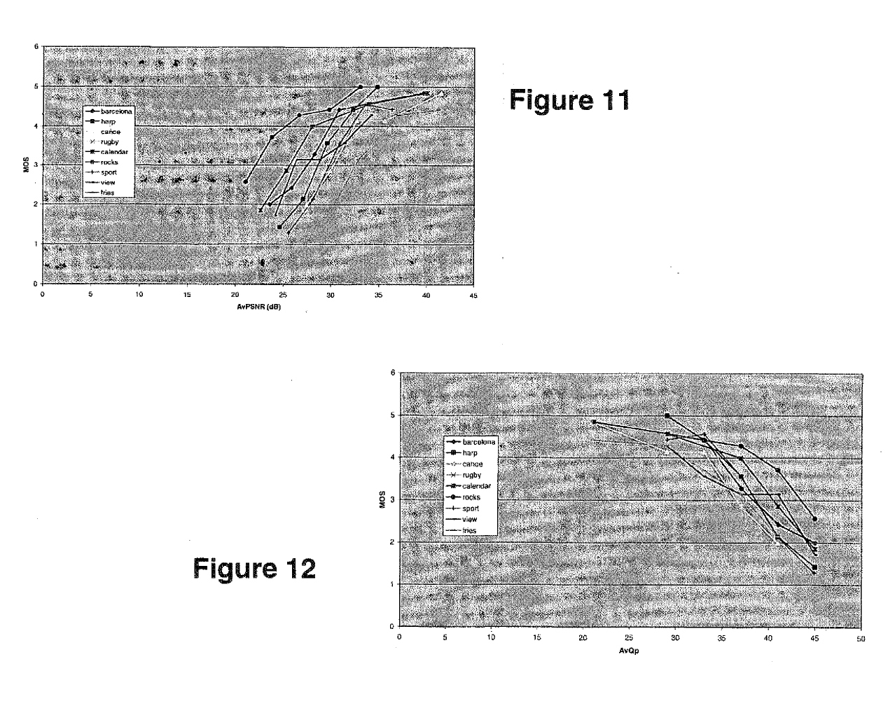

FIG. 11 shows AvPSNR vs. measured MOS for training sequences;

FIG. 12 shows AvQP vs. measured MOS for training sequences;

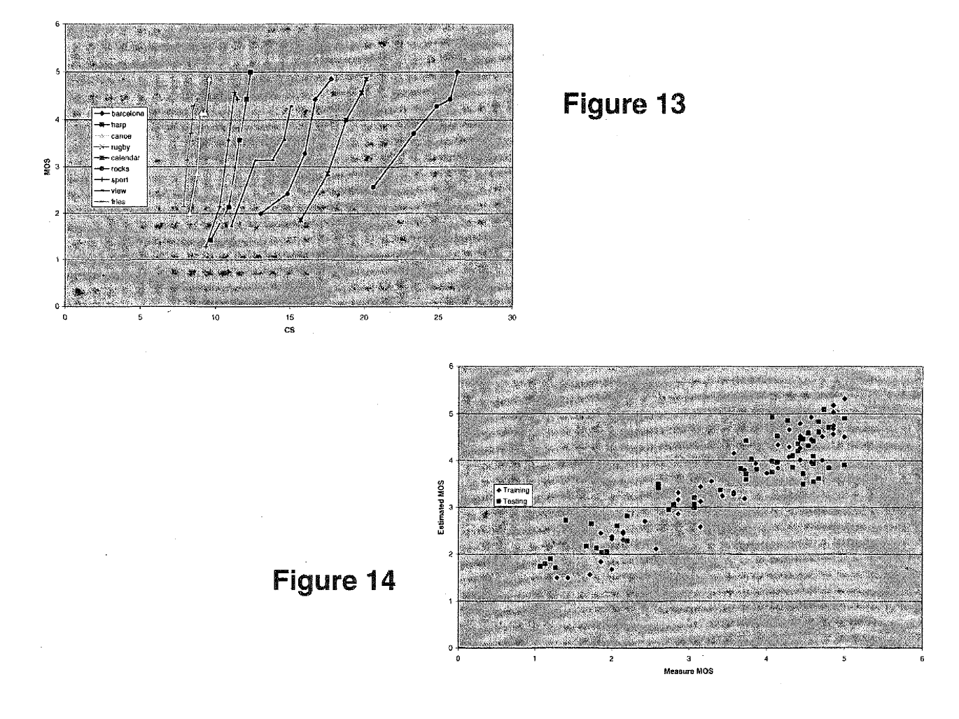

FIG. 13 shows CS vs. measured MOS for training sequences; and

FIG. 14 shows measured vs. estimated MOS for AvQP/CS model.

There will now be described in detail a method and system for encoding a video signal in which the aim is to provide, at the encoding end of a communications link, an encoded signal that is compressed in order that it may be efficiently transmitted over the link whilst also meeting a predetermined standard in terms of its estimated perceptual quality when the signal is decoded and displayed. This is achieved by providing, at the encoding end, a control unit which utilises a perceptual quality metric (PQM) system to quantify the estimated perceptual quality, and control logic that compares said quantified PQM with a user-defined criterion that the signal must meet prior to transmission. The signal is only transmitted onwards over the communications link if the criterion is met. Otherwise, the control system is operable either to modify the signal, e.g. using pre-filtering, or use modified encoding parameters to re-encode the signal in such a way as to improve its quality, that is to make the quantified PQM converge towards the criterion. A number of iterations of this encode-modify-encode sequence may be required before the resulting PQM meets the criterion and so be transmitted. Advantageously, once initial parameters for encoding and the criterion are set by the user, the system can operate automatically and so a provider of video content has increased confidence that viewers will decode and view content that meets a minimum level of service, or an improved level of service, with minimal interaction required of the provider.

Referring to FIG. 1, an example of a commercial system that may advantageously employ such an encoding system is shown. Here, a content service provider 10 transmits video content in digital form to a plurality of customers who receive and decode the digital signal using their respective set top boxes (STBs) 12 for output to television sets (TVs) 14. The content may be transmitted in a number of ways, for example over a wireless link using a terrestrial broadcast antenna 16, or over a ‘wired’ connection such as an IP link 18 utilising copper or fibre-optic cable. The latter method is becoming increasingly popular and is commonly referred to as IPTV. Satellite broadcasting is a further option. Indeed, some service providers implement a combination of communication methods, for example by broadcasting free-to-air content over the wireless link whilst providing video on demand (VOD) services using the IPTV link. Whichever method is used, the service provider 10 is required to encode the video signal in such a way that the source digital signal is compressed so that it can be efficiently transmitted over the limited bandwidth link between service provider and customer STB 12. This process is sometimes referred to as source encoding and a number of encoding algorithms or standards are known. The following description will assume the use of the H.264/MPEG-4 AVC standard although it is to be understood that any other video encoding standards can be used. At each of the STBs 12, a decoder is provided for decoding the received signal in accordance with the standard used at the encoder.

Referring to FIG. 2, a block diagram of a generalised encoding system employing the abovementioned quality control function is shown. Source video 20 is supplied to an encoder 22 arranged to operate in accordance with a chosen encoding standard. The source video 20 represents, in digital form, video content which comprises a sequence of frames, each frame comprising n×m picture elements or pixels. The encoder 22 operates in accordance with a number of user-defined parameters, particularly the encoding bit-rate and also, optionally, an encoding profile. Regarding the latter, certain encoding standards define particular encoding profiles which provide a predetermined level of compression. In addition to bit-rate and encoding profile, the user also specifies quality thresholds which define a range of quality values corresponding to an acceptable level of perceptual quality. The user may also set an optimum target quality. Although shown supplied to the encoder 22, the quality thresholds and target can be supplied directly to the next stage, namely a control unit 24.

The control unit 24 is arranged to receive the encoded video data and the abovementioned quality thresholds and target quality. Within the control unit 24 is a PQM system 32 which generates a numerical value or values that can subsequently be used to indicate the perceptual quality of individual frames, or groups of frames, depending on what the service provider requires. In the specific example given below, we generate a measure called the mean opinion score (MOS) which is the quality parameter we will generally refer to from now on. The range of MOS values that the PQM system 32 is capable of generating is predetermined and a number of standardised systems are provided by the ITU-R Recommendation. FIG. 3a shows a five point scale in which the value ‘one’ indicates a bad level of perceptual quality whilst ‘five’ represents excellent quality. FIG. 3b shows an alternative one to one-hundred scale where ‘zero’ represents the lowest quality and ‘one-hundred’ the highest quality. The PQM system 32 can comprise any known PQM system, for example a full reference, no reference or reduced reference system. It is assumed that the reader is aware of the different types and their general principle of operation. In the case of a pure no reference PQM system, access to the raw encoded bit-stream is all that is required. In the case of a full reference PQM system, a copy of the source video is required, hence the presence of the dotted line in FIG. 2. Reduced reference PQM systems require some, but not all, information about the source content. In the detailed description that follows, we describe the use of a hybrid bit-stream/decoder no-reference PQM system 32 which requires both the bit-stream and a decoded version of the content in order to generate different quality information. Hence the PQM system 32 will include a decoder, an H.264 decoder in this particular case.

The type of information that can be generated by a PQM system includes the following non-exhaustive list of parameters:
per field/frame mean opinion score MOS_{Fn}
video unit/group of pictures mean opinion score MOS_{GOP}
temporal change in quality (MOS_{Fn}-MOS_{Fn-1})
video unit change in mean opinion score (MOS_{GOP(k)}-MOS_{GOP(k-1)})
spatial complexity
spatial masking
temporal complexity
quantiser step-size (per field/frame)
bit-rate
slice structure
macroblock size and composition
motion vector values.

Also provided within the control unit 24 is control logic 34 which is arranged to receive the or each parameter generated by the PQM system 32 (in the detailed example below a single MOS value is used) to determine whether or not the quality measure so indicated falls within the range of quality values defined by the user-input threshold and target values. If so, the control logic 34 ‘passes’ the video and it is either stored in preparation for subsequent transmission, or transmitted immediately. Otherwise, the control logic 34 ‘fails’ the video and it is not transmitted or stored. Instead, the video data, i.e. the source video data corresponding to the failing frame or group of frames, is again encoded either with the video data being pre-filtered prior to encoding and/or by using modified encoding parameters, typically modified values of quantisation step size (QSS) or encoding bit rate. The choice of whether to pre-filter or modify encoding parameters is based on predetermined modification rules provided as part of the control unit's logic 34. The rules are defined such that, in the next encoding iteration, the quality measure will at least be closer to the acceptable quality range defined by the thresholds. Further, the type and/or amount of modification that is applied is dependent on one or more of the parameters generated by the PQM system 32, as will be explained below. FIG. 2 indicates a separate module 28 as providing a control signal to the source video to indicate the frame or groups of frames requiring re-encoding and the updated parameter set for the encoder 22. In practice this may form an integral part of the control unit 24.

As mentioned previously, a number of re-encoding iterations may be required before the quality measure is within range and the video passed for storage and/or onwards transmission. In certain time critical applications, the number of iterations can be limited to a predetermined number after which the video data is transmitted.

The operating procedure of the generalised encoding system will now be described.

Initially, source video 20 is submitted to the encoder. The operator sets the relevant encoding parameters, e.g. QSS, encoding bit-rate, encoding profile, and quality thresholds. The encoded output is then passed to the PQM system 32 of the control unit 24. Depending on the type of PQM system, the encoded video may require decoding, for example if the PQM system 32 uses a full-reference or hybrid bit-stream/decoder method. Perceptual quality measurements are obtained for each frame, the measurements providing one or more of the parameters listed previously. The measurement method may output instantaneous and local measures of quality, for example MOSi, MOS_{GOP}. The next stage involves testing the quality measurement or measurements against the range defined by the quality thresholds. The testing may use any one or combination of the quality parameters, although in the embodiment we describe below, a single quality parameter is generated and tested. It is considered that the MOS_{GOP} measure is the most important since it is considered that occasional dips below MOSi threshold values should be tolerated. Further, it is suggested that decisions to act on failed content take into account multiple GOPs in order to modulate the quality in line with the target quality whilst operating preferred or required bit-rate limits.

Video content that falls within the quality thresholds is passed for storage or transport. Content that fails the quality threshold test in the control logic is re-encoded using a pre-filtered version of the content and/or using modified encoding parameters. Although we describe the use of thresholds to define an acceptable quality range, it will be appreciated that the system will function correctly using only a lower threshold with anything falling above this threshold passing the quality test. However, in our detailed implementation, both upper and lower thresholds are set and in certain circumstances it can be advantageous to re-encode data that falls outside the upper, i.e. high quality, threshold.

Where the control logic of the control system determines that modified encoding parameters are required, these are generated in accordance with predetermined rules and sent back to the encoder. The process can operate iteratively to encode, measure, re-encode and so on until the video quality is acceptable, or where a predefined maximum iteration count is reached. New values may be provided for all or a subset of the encoding parameters, e.g. QSS, encoding profile, encoding bit-rate etc. In a very simple example, the encoding bit-rate might be encoded, e.g. by modifying the bit-rate by a certain percentage value for each iteration or alternatively by referring to a look-up table (LUT). The LUT may be defined by processing large content databases through the PQM system 32 in advance. The LUT is then constructed with MOS values produced alongside video attributes, e.g. of differing spatial or temporal complexity, and encoder parameter values, e.g. quantisation maps. Once content has been measured in the PQM system 32 of the control unit 24, properties of the failed content are then mapped to the LUT together with the quality thresholds and, from the LUT, a new parameter or parameter set is generated and passed to the encoder 22.

Perceptual models (used by PQM systems) that perform spatial error mapping can use perceptual quality information to target particularly error-prone parts of an image to improve quality. For example, in defining a new encoder parameter set, frames that meet the quality criterion will not have new values generated whereas failed frames will have new parameter sets. Similarly, in the spatial domain, parts of the image that are within the quality bounds will not be provided with new encoding values, but regions of the image that do fail the quality test can have new parameters assigned. Where bit-rate is a major constraint, the method operates by examining spatio-temporal quality across a number of GOPs, e.g. the set of GOPs equivalent to the size of the relevant receiver buffer, such that (a) frame or parts of frames that are above or at the top of upper quality bound are reduced in quality, e.g. by increasing the QSS, and/or (b) frames or parts of frames that are at, or below, the lower quality bound are increased in quality, e.g. by reducing the QSS.

As an alternative to modifying the encoding parameters, the control logic 34 may determine that altering the actual source video 20 is appropriate, i.e. by pre-filtering. By identifying problematic parts of the encoded video, it is possible to use the quality measurements to target segments or regions of the source video that will stress the encoder 22. For example, where certain parts of the source video 20 are identified as having high motion or fine detail, and exhibit poor quality at the PQM system 32, specific pre-filtering can be applied. The control unit 24 can send instructions to a pre-filter to modify the corresponding source content e.g. by reducing image resolution or applying a spatial frequency filter, with a view to improving the quality of the data for the next iteration.

A more detailed example of an encoding system employing a quality control unit will now be described.

Referring to FIG. 4, the encoding system utilises an H.264 encoder 42 to encode source content 40 provided as a sequence of frames Fn. The structure and operation of the H.284 encoder 42 is well known and a detailed description will not be given here. Generally, a first stage 44 performs prediction coding, including motion estimation and motion compensation, to produce prediction slices and data residual values. In subsequent stages, transform coding 46, quantisation 48, picture re-ordering 50 and entropy coding 52, e.g. using CAVCL or CABAC, is performed. The encoded output data is placed into signalling/data packets, referred to here as Network Abstraction Layer (NAL) units 54.

The encoding system further comprises a quality control unit (QCU) 56 which, like the generalised control unit 24 shown in and described with reference to FIG. 2, includes a PQM system 32 and control logic 34 for measuring the estimated perceptual quality of the encoded data, determining whether the quality meets a predefined quality criterion, and if not, modifying the signal and/or its encoding to improve quality. The signal is modified using a pre-processing filter 62. Encoding is modified by means of modifying one or more parameters input to the quantiser part 48 of the H.264 encoder 42. In the event that QCU 56 passes the encoded video, it is transferred to a video buffer 60 for subsequent transmission over a communication link/channel.

In use, the operator sets a target encoding bit-rate of 2 Mbit/s and a 2 second receiver buffer is specified. The operator also defines the quality criterion by specifying upper and lower bounds, and a target quality. The five-point scale shown in FIG. 3a is employed and example values of upper=4.0, lower=2.8 and target=3.4 are used. The number of encode-measure-re-encode iterations is limited to three. All values are input to the encoder 42, although the bounds, target and iteration limit can be fed directly to the QCU 56.

The encoded NAL units 58 are sent to the QCU 56. The aim is to generate video content that is of a relatively consistent quality above the lower bound and preferably around the target quality with no or minimal failed GOPs, or frames within GOPs.

The QCU 56 performs perceptual quality measurement using a PQM system, which can be any type of known PQM system 32. For the purposes of illustration, we employ a hybrid bit-stream/decoder PQM system as described in our co-pending International Patent Application No. GB2006/004155, the contents of which are incorporated herein by reference. Further details of this type of PQM system are given at the end of this description.

The PQM system 32 operates on segments of the video data in accordance with the two second receiver buffer. That is, a two second buffer (not shown) is provided between the encoder and PQM system with the latter being arranged to receive and analyse GOPs received from this buffer. The QCU 56 and encoder 42 operate in tandem so that no further GOPs are fed into the PQM system 32 from the buffer until the current GOPs have been dealt with, that is until they have been passed for transmission. Only when this occurs are new GOPs received. For failed content, the encoder 42 will receive instructions on modified values for the quantiser 48, or will await new source content to be input following pre-filtering. To this end, the OCU 56 is arranged to generate one of the following control signals to the encoder 42:

| Control Signal | Meaning |
|---|---|
| 0 | pass video, encode next two second content segment |
| 1 | fail video, await new quantiser parameters, e.g. QSS, |
| | bit-rate |
| 2 | fail video, await new pre-filtered source input. |

Within the OCU 56 a number of rules are provided which determine how failed video is subsequently to be processed, that is to determine what, if any, pre-filtering is to be applied and/or how quantisation parameters are to be modified. The rules involve identifying which one of three quality profiles A-C the failed segment falls into. Each profile is now considered in relation to a real-life scenario, together with corresponding actions taken by the QCU logic 34 in response to identification of the relevant profile. For this purpose, we assume a video data segment representing two seconds of PAL video and therefore comprising fifty frames. We assume each GOP comprises ten frames.

### Profile A: Entire or Most of Segment Fails

In this scenario, the entire two second segment of data fails to meet the quality criterion. FIG. 5 shows, in graphical form, the output that might result in this situation. There is little room to manipulate the encoding process to meet the quality requirements for all GOPs and so in this case we pre-filter the source video prior to re-encoding. Control signal ‘2’ is sent to the encoder 42. Pre-filtering will reduce the complexity of the video by performing one or both of spatial and temporal frequency filtering. Alternatively, the image may be reduced, e.g. from its full resolution down to three-quarters or two-thirds resolution. The filtered source is then passed to the encoder 42 and the iteration count is incremented.

Profile B: Most of Segment Passes with Some Failure

In this scenario, a minority of the segment under consideration has failed. FIG. 6 shows, in graphical form, the output that might result. A period of the segment, GOP5-GOP7 falls below the lower bound. In this case, the QCU is commanded to extract information about the failed GOPs and generate revised encoding parameters such as QSS. A control signal ‘1’ is passed to the encoder 42. In addition, target GOPs are identified as being good candidates for a reduction in quality, in this case GOP3, GOP9 and GOP10. In this respect, it will be appreciated that in order to improve the quality of the failed GOPs, there will be a compression cost by reducing QSS. If we can identify GOPs that are above the target quality, we might reduce their quality in a controlled way so as to compensate whilst of course meeting the minimum quality requirement. Indeed, secondary GOP candidates can also be identified, e.g. GOP1, GOP2 and GOP8.

The control logic 34 within the QCU 56 is arranged to generate revised QSS values for all GOPs 1-10. These revised QSS values are obtained either by reference to a LUT or by adjusting QSS for each frame in the relevant GOP. For example, where a GOP is below the lower bound, the QSS can be decreased by 1 for each 0.5MOS below said lower bound. Where the quality falls within the range, only those GOPs that are 0.5MOS above the lower quality bound are modified, for example by increasing QSS by 1 for each 0.5MOS above. Note that these modification figures are examples and smaller or larger values may be used for different quality ranges. For small quality ranges, small changes in MOS should be used to adjust the QSS. Table 1 below shows example changes in QSS associated with each GOP shown in FIG. 6. These new parameter values are passed directly to the quantiser of the encoder 42 which, having received the control signal ‘1’ re-encodes the GOPs. The iteration count is incremented and the process continues until either the QCU 56 determines that the content meets the quality requirements or the maximum iteration count of three is met.

TABLE 1
Example measurement values and resulting change in
Quantisation Parameter

| GOP# | MOS_{target} | MOS_{lower} | MOSᵤₚₚₑᵣ | MOS_{GOP} | QP_{change} |
|---|---|---|---|---|---|
| 1 | 3.4 | 2.8 | 4 | 3.3 | 1 |
| 2 | 3.4 | 2.8 | 4 | 3.35 | 1 |
| 3 | 3.4 | 2.8 | 4 | 3.5 | 2 |
| 4 | 3.4 | 2.8 | 4 | 3.2* | −1 |
| 5 | 3.4 | 2.8 | 4 | 2.3 | −2 |
| 6 | 3.4 | 2.8 | 4 | 2.3 | −2 |
| 7 | 3.4 | 2.8 | 4 | 2.6 | −1 |
| 8 | 3.4 | 2.8 | 4 | 3.2 | 0 |
| 9 | 3.4 | 2.8 | 4 | 3.45 | 2 |
| 10 | 3.4 | 2.8 | 4 | 3.4 | 2 |

It is worth noting that GOP4 has a large change in quality across its constituent frames. A method to account for this can be employed in which the average MOS is examined together with the change in MOS across the frames. If the percentage of frames below the quality threshold is greater than, say, 30%, then the QCU could re-calculate the MOS for below-threshold frames only and apply a QSS change to these frames only, leaving above-quality threshold frames within the GOP unchanged (or where the above-threshold frames are >0.5MOS the QSS for these frames could be increased). The figures indicated in Table 2 below indicate this approach for handling variable quality GOPs. Again, note that the 30% threshold is simply an example.

This differential modulation of QSS across frames within an individual GOP can also be applied to GOPs where all frames are below the quality threshold. Where the fail range is very variable, some frames may require a decrease of, say, 2, whereas others may require a change of around 1. For GOPs that contain only a few failing frames, e.g. less than 30%, these may be ignored.

TABLE 2
Example measurement values and resulting change in Quantisation
Parameter for individual frames within GOP#4

| Frame# | MOS_{target} | MOS_{lower} | MOSᵤₚₚₑᵣ | MOS_{frame} | QP_{change} |
|---|---|---|---|---|---|
| 1 | 3.4 | 2.8 | 4 | 3.4 | 1 |
| 2 | 3.4 | 2.8 | 4 | 3.3 | 1 |
| 3 | 3.4 | 2.8 | 4 | 3.2 | 0 |
| 4 | 3.4 | 2.8 | 4 | 3 | 0 |
| 5 | 3.4 | 2.8 | 4 | 2.9 | 0 |
| 6 | 3.4 | 2.8 | 4 | 2.75 | −1 |
| 7 | 3.4 | 2.8 | 4 | 2.7 | −1 |
| 8 | 3.4 | 2.8 | 4 | 2.65 | −1 |
| 9 | 3.4 | 2.8 | 4 | 2.6 | −1 |
| 10 | 3.4 | 2.8 | 4 | 2.55 | −1 |

Profile C: Most of Segment Passes with Failing Parts Below and Above Bounds

This scenario is indicated, in graphical form, in FIG. 7. Some content has failed by being below the lower bound, some content has failed by being too good, i.e. above the upper bound, with the remaining content falling within the quality bounds. As before, the QCU 56 modifies each GOP, or frames within variable quality GOPs, as described above. In this instance, however, the first iteration will deal with those GOPS that are outside of the quality range, i.e. GOP2, GOP4, GOP5, GOP6, GOP7, GOP9 and GOP10, by raising the quality for GOPs 2, 4, 9 and 10 whilst paying for this improvement by decreasing the quality for GOPs 5, 6 and 7.

Profiles B and C are intended to handle similar situations, i.e. where most of the segment passes but with some failure. Both examples illustrate how adapting the QSS can be used to recover failed parts of the video. In Profile B, the idea is to show how failed parts of the video may be improved, both for GOPs and for frames. The GOP example is confined to the situation where there is only fail or target quality across GOPs. Some target quality GOPs have QSS increased and this is used to pay for reductions in as for failed GOPs, although the trade-off is not necessarily balanced—more reductions than increases in QSS may be applied. The frame example illustrates how modification of QSS may be applied across a single GOP that experiences dramatic variation in quality, with some target and some fail. Again an unbalanced trade-off in QSS may be used to get the frame quality within a GOP within the quality bounds. The purpose of Profile C is really to show how modification of QSS (or other parameter(s)) may be applied when a set of GOPs have 3 levels of quality, namely fail, target and beyond target, i.e. too good. We know that consistent quality is preferable for user experience and by taking from the ‘too good’ segments and giving to the ‘fail’ segments we can get a more predictable and consistent quality across the GOPs.

For all examples provided here, where the operator has the capability to transmit content that consistently exceeds the target bit-rate, an increase in the bit-rate may be applied in order to meet the quality target. In this instance, a signal would be sent to the encoder 42 to increase the target bit-rate for the content. This method provides a perceptually-sensitive method to dynamically adjust the bit-rate applied to a video signal. A look-up table such as that described above may be referred to in order for the QCU 56 to select a new encoding rate. Given that QSS is known to be a particularly useful quality indicator, and that it is central to the PQM used in this example, QSS has been used instead of bit-rate. Where the quality profile is all fail, as in profile A described above, then modifying the bit-rate may be more appropriate. However, because target bit-rate is a major constraint on encoding, and operators usually set a target bit-rate expecting it to be met, it is assumed that either pre-filtering or modulating QSS are the best approaches when using the hybrid bit-stream/decoding PQM system 32 used in this example.

To conclude, there is now described an example of a perceptual quality measurement method and system that can be employed in the above-described PQM system 32. It will be appreciated that other such measurement methods can be employed.

### Perceptual Quality Measurement System

The purpose of the system is to generate a measure of quality for a video signal representative of a plurality of frames, the video signal having: an original form; an encoded form in which the video signal has been encoded using a compression algorithm utilising a variable quantiser step size such that the encoded signal has a quantiser step size parameter associable therewith; and, a decoded form in which the encoded video signal has been at least in part reconverted to the original form, the system being arranged to perform the steps of: a) generating a first quality measure which is a function of said quantiser step size parameter; b) generating a second quality measure which is a function of the spatial complexity of at least part of the frames represented by the video signal in the decoded form; and, c) combining the first and second measures.

Because the step size is derivable from the encoded video sequence, and because the complexity measure is obtained from the decoded signal, the need to refer to the original video signal is reduced. Furthermore, because in many encoding schemes the step size is transmitted as a parameter with the video sequence, use can conveniently be made of this parameter to predict video quality without having to calculate this parameter afresh. Importantly, it has been found that use of the complexity measure in combination with the step size improves the reliability of the quality measure more than would simply be expected from the reliability of the step size or the complexity alone as indicators of video quality.

### Overview of System

The embodiment below relates to a no-reference, decoder-based video quality assessment tool. An algorithm for the tool can operate inside a video decoder, using the quantiser step-size parameter (normally a variable included in the incoming encoded video stream) for each decoded macroblock and the pixel intensity values from each decoded picture to make an estimate of the subjective quality of the decoded video. A sliding-window average pixel intensity difference (pixel contrast measure) calculation is performed on the decoded pixels for each frame and the resulting average (TCF) is used as a measure of the noise masking properties of the video. The quality estimate is then made from a weighting function of the TCF parameter and an average of the step-size parameter. The weighting function is predetermined by multiple regression analysis on a training data base of characteristic decoded sequences and previously obtained subjective scores for the sequences. The use of the combination of, on the one hand the step-size and, on the other hand, a sliding-window average pixel intensity difference measure to estimate the complexity provides a good estimate of subjective quality.

In principle the measurement process used is applicable generally to video signals that have been encoded using compression techniques using transform coding and having a variable quantiser step size. The version to be described however is designed for use with signals encoded in accordance with the H.264 standard. The process also applies the other DCT based standard codecs, such as H.261, H.263, and MPEG-2 (frame based).

The measurement method is of the non-intrusive or “no-reference” type—that is, it does not need to have access to a copy of the original signal. The method is designed for use within an appropriate decoder, as it requires access to both the parameters from the encoded bit-stream and the decoded video pictures.

In the apparatus shown in FIG. 8, the incoming signal is received at an input 1 and passes to a video decoder which decodes and outputs the following parameters for each picture:

Decoded picture (D).
Horizontal decoded picture size in pixels (Pₓ)
Vertical decoded picture size in pixels (P_{y})
Horizontal decoded picture in macroblocks (Mₓ)
Vertical decoded picture size in macroblocks (M_{y})
Set of quantiser step-size parameters (Q).

There are two analysis paths in the apparatus, which serve to calculate the picture-averaged quantiser step-size signal QPF (unit 3) and the picture-averaged contrast measure CF (unit 4). Unit 5 then time averages signals QPF and CF to give signals TQPF and TCF respectively. Finally, these signals are combined in unit 6 to give an estimate PMOS of the subjective quality for the decoded video sequence D. The elements 3 to 6 could be implemented by individual hardware elements but a more convenient implementation is to perform all those stages using a suitably programmed processor.

### Picture-Average Q

This uses the quantiser step size signal, Q, output from the decoder. Q contains one quantiser step-size parameter value, QP, for each macroblock of the current decoded picture. For H.264, the quantiser parameter OP defines the spacing, QSTEP, of the linear quantiser used for encoding the transform coefficients. In fact, QP indexes a table of predefined spacings, in which QSTEP doubles in size for every increment of 6 in OP. The picture-averaged quantiser parameter QPF is calculated in unit 3 according to

$$QPF = ( 1 / {M}_{X} * {M}_{Y} ) {\sum }_{i = 0}^{{M}_{X} - 1} {\sum }_{j = 0}^{{M}_{Y} - 1} Q ( i , j ) \qquad ( 1 )$$

where Mx and My are the number of horizontal and vertical macroblocks in the picture respectively and Q(i,j) is the quantiser step-size parameter for macroblock at position (i,j).

### Calculate Contrast Measure

FIGS. 9 and 10 illustrate how the contrast measure is calculated for pixels p(x,y) at position (x,y) within a picture of size Px pixels in the horizontal direction and Py pixels in the vertical direction.

The analysis to calculate the horizontal contrast measure is shown in FIG. 9. Here, the contrast measure is calculated in respect of pixel p(x,y), shown by the shaded region. Adjacent areas of equivalent size are selected (one of which includes the shaded pixel) Each area is formed from a set of (preferably consecutive) pixels from the row in which the shaded pixel is located. The pixel intensity in each area is averaged, and the absolute difference in the averages is then calculated according to equation (2) below, the contrast measure being the value of this difference. The vertical contrast measure is calculated in a similar fashion, as shown in FIG. 10. Here, an upper set of pixels and a lower set of pixels are select. Each of the selected pixel lie on the same column, the shaded pixel next to the border between the upper and lower sets. The intensity of the pixels in the upper and lower sets is averaged, and the difference in the average intensity of each set is then evaluated, the absolute value of this difference being the vertical contrast measure as set out in equation (3) below, that is, a measure of the contrast in the vertical direction. In the present example, the shaded pixels is included in the lower set. However, the position of the pixel with which the contrast measure is associated is arbitrary, provided that it is in the vicinity of the boundary shared by the pixels sets being compared.

Thus, to obtain the horizontal contrast measure, row portions of length H are compared, whereas to obtain the vertical contrast measure, column portions of length V are compared (the length H and V may but need not be the same). The contrast measure is associated with a pixel whose position that is local to the common boundary of, on the one hand, the row portions and on the other hand the column portions.

The so-calculated horizontal contrast measure and vertical contrast measure are then compared, and the greatest of the two values (termed the horizontal-vertical measure as set out in equation (4)) is associated with the shaded pixel, and stored in memory.

This procedure is repeated for each pixel in the picture (within a vertical distance V and a horizontal distance H from the vertical and horizontal edges of the picture respectively), thereby providing a sliding window analysis on the pixels, with a window size of H or V. The horizontal-vertical measure for each pixel in the picture (frame) is then averaged to give the overall pixel difference measure CF (see equation (5)). This overall measure associated with each picture is then averaged over a plurality of pictures to obtain a sequence-averaged measure, that is, a time averaged measure TCF according to equation (7). The number of pictures over which the overall (CF) measure is averaged will depend on the nature of the video sequence, and the time between scene changes, and may be as long as a few seconds. Clearly, only part of a picture need be analysed in this way, in particular if the quantisation step size varies across a picture.

By measuring the contrast at different locations in the picture and taking the average, a simple measure of the complexity of the picture is obtained. Because complexity in a picture can mask distortion, and thereby cause an observer to believe that a picture is of a better quality for a given distortion, the degree of complexity in a picture can be used in part to predict the subjective degree of quality a viewer will associate with a video signal.

The width (H) or height (V) of the respective areas about the shaded pixel is related to the level of detail at which an observer will notice complexity. Thus, if an image is to be viewed from afar, H and V will be chosen so as to be larger than in situations where it is envisaged that the viewer will be closer to the picture. Since in general, the distance from a picture at which the viewer will be comfortable depends on the size of the picture, the size of H and V will also depend on the pixel size and the pixel dimensions (larger displays typically have larger pixels rather than more pixels, although for a given pixel density, the display size could also be a factor). Typically, it is expected that H and V will each be between 0.5% and 2% of the respective picture dimensions. For example, the horizontal value could be 4*100/720=0.56%, where there are 720 pixels horizontally and each set for average contains 4 pixels, and in the vertical direction, 4*100/576=0.69% where there are 576 pixels in the vertical direction.

The analysis for calculating the contrast measure can be described with reference to the equations below as follows: the calculation uses the decoded video picture D and determines a picture-averaged complexity measure CF for each picture. CF is determined by first performing a sliding-window pixel analysis on the decoded video picture. In FIG. 2, which illustrates horizontal analysis for pixel p(x,y) within a picture of size Pₓ horizontal and P_{y} vertical pixels, the horizontal contrast measure Cₕ is calculated for the n′th picture of decoded sequence D according to:

$${C}_{h} ( n , x , y ) = ( 1 / H ) ( abs ( \begin{matrix}( {\sum }_{j = 0}^{H - 1} D ( n , x - j , y ) ) - \\ ( {\sum }_{j = 0}^{H - 1} D ( n , x + 1 + j , y ) )\end{matrix} ) ) \\ x = H - 1 … {P}_{X} - H - 1 \\ y = 0 … {P}_{Y} - 1 \qquad ( 2 )$$

H is the window length for horizontal pixel analysis. Cₕ(n,x,y) is the horizontal contrast parameter for pixel p(x,y) of the n′th picture of the decoded video sequence D. D(n,x,y) is the intensity of pixel p(x,y) of the n′th picture of the decoded video sequence D.

In FIG. 10, which illustrates the corresponding vertical pixel analysis, the vertical contrast measure C, is calculated by:

$${C}_{v} ( n , x , y ) = ( 1 / Y ) ( abs ( \begin{matrix}( {\sum }_{j = 0}^{V - 1} D ( n , x , y - j ) ) - \\ ( {\sum }_{j = 0}^{V - 1} D ( n , x , y + 1 + j ) )\end{matrix} ) ) \\ x = 0 … {P}_{X } - 1 \\ y = V - 1 … {P}_{Y} - V - 1 \qquad ( 3 )$$

Here, V is the window length for vertical pixel analysis.
Cₕ and Cᵥ may then be combined to give a horizontal-vertical measure Cₕᵥ, where

Cₕᵥ(n,x,y)=max(Cₕ(n,x,y),Cᵥ(n,x,y))

x=H−1 . . . P_{X}−H−1

y=V−1 . . . P_{Y}−V−1 (4)

It should be noted here that for some applications it may be better to leave horizontal and vertical components separate to allow different weighting parameters to be applied to each in the estimation of the subjective quality (unit 6).

Finally, an overall picture-averaged pixel difference measure, CF, calculated from the contrast values Cₕ, Cᵥ and/or Cₕᵥ according to

$$CF ( n ) = ( \begin{matrix}1 / ( {P}_{X} + 1 - 2 H ) \\ ( {P}_{Y} + 1 - 2 V )\end{matrix} ) {\sum }_{y = V - 1}^{{P}_{Y} - V - 1} {\sum }_{x = H - 1}^{{P}_{X} - H - 1} C ( n , x , y ) \qquad ( 5 )$$

### Time Average

This uses the picture-averaged parameters, QPF and CF, and determines corresponding time-averaged parameters TQPF and TCF according to:

$$\begin{matrix}TQPF = ( 1 / N ) {\sum }_{n = 0}^{N - 1} QPF ( n ) & ( 6 ) \\ TCF = ( 1 / N ) {\sum }_{n = 0}^{N - 1} CF ( n ) & ( 7 )\end{matrix}$$

The parameter averaging should be performed over the time-interval for which the MOS estimate is required. This may be a single analysis period yielding a single pair of TQPF and TCF parameters or maybe a sequence of intervals yielding a sequence of parameters. Continuous analysis could be achieved by “sliding” an analysis window in time through the CF and QPF time sequences, typically with a window interval in the order of a second in length.

### Estimate MOS

This uses time-averaged parameters TQPF and TCF to make an estimate, PMOS, of the subjectively measured mean opinion score for the corresponding time interval of decoded sequence, a TQPF contributes an estimate of the noise present in the decoded sequence and TCF contributes an estimate of how well that noise might be masked by the content of the video sequence. PMOS is calculated from a combination of the parameters according to:

PMOS=F₁(TPQF)+F₂(TCF)+K₀ (8)

F₁ and F₂ are suitable linear or non-linear functions in AvQp and CS. K₀ is a constant. PMOS is the predicted Mean Opinion Score and is in the range 1.5, where 5 equates to excellent quality and 1 to bad. F₁, F₂ and K₀ may be determined by suitable regression analysis (e.g. linear, polynomial or logarithmic) as available in many commercial statistical software packages. Such analysis requires a set of training sequences of known subjective quality. The model, defined by F1, F2 and K₀, may then be derived through regression analysis with MOS as the dependent variable and TQPF and TCF as the independent variables. The resulting model would typically be used to predict the quality of test sequences that had been subjected to degradations (codec type and compression rate) similar to those used in training. However, the video content might be different.

For H.264 compression of full resolution broadcast material, a suitable linear model was found to be:

PMOS=−0.135*TPQF+0.04*CS+7.442 (9)

The resulting estimate would then be limited according to:

if (PMOS>5)PMOS=5

if (PMOS<1)PMOS=1 (10)

Below there is provided an additional discussion of various aspects of the above embodiment.

Introduction: full-reference video quality measurement tools, utilising both source and degraded video sequences in analysis, have been shown to be capable of highly accurate predictions of video quality for broadcast video. The design of no-reference techniques, with no access to the pre-impaired “reference” sequence, is a tougher proposition.

Another form of no-reference analysis may be achieved through access to the encoded bitstream, either within a decoder or elsewhere in the network. Such “bitstream” analysis has the advantage of having ready access to coding parameters, such as quantiser step-size, motion vectors and block statistics, which are unavailable to a frame buffer analysis. Bitstream analysis can range from computationally light analysis of decoded parameters, with no inverse transforms or motion predicted macroblock reconstruction, through to full decoding of the video sequence.

PSNR is a measure used in the estimate of subjective video quality in both video encoders and full-reference video quality measurement tools. In no-reference tools, PSNR can't be calculated directly, but may be estimated. Here we present a no-reference video quality prediction technique operating within an H.264/AVC decoder that can outperform the full-reference PSNR measure.

Firstly, results are presented to benchmark quality estimation using the PSNR measure for a variety of H.264 encoded sequences. Secondly, consideration is given to a bitstream technique, that uses a measure of average quantiser step-size (AvQP) to estimate subjective quality. Rather than just being an approximation to PSNR, it is shown that this bitstream, no-reference measure can outperform the full-reference PSNR measure for quality estimation. Finally, a measure of noise masking (CS) is introduced, that further enhances the performance of both PSNR and quantiser step-size based quality estimation techniques. The measure is based on a pixel difference analysis of the decoded image sequence and calculated within the video decoder. The resulting decoder based no-reference model is shown to achieve a correlation between measured and estimated subjective scores of over 0.91.

Video Test Material—Training and Testing Database: the video database used to train and test the technique consisted of eighteen different 8-second sequences, all of 625 broadcast format. The training set was made up of nine sequences, with six of the sequences from the VQEG1 database and the remaining three sourced from elsewhere. The test set consisted of nine different sequences. The VQEG1 content is well known and can be downloaded from the VQEG web site. As the quality parameters were to be based on averages over the duration of each sequence, it was important to select content with consistent properties of motion and detail. Details of the sequences are shown in Table 4.

TABLE 4
Training and test sequences.

| Training | | Test | |
|---|---|---|---|
| Sequence | Characteristics | Sequence | Characteristics |
| Barcelona | Saturated colour, slow | Boat | Water, slow movement. |
| | zoom. | | |
| Harp | Slow zoom, thin | Bridge | Detail, slow movement. |
| | detail. | | |
| Canoe | Water movement, pan, | Ballroom | Patterns and movement. |
| | detail. | | |
| Rugby | Movement, fast pan. | Crowd | Movement. |
| Calendar | High detail, slow pan. | Animals | Colour tones, movement. |
| Fries | Fast pan, film. | Fountain | Water movement. |
| Rocks | Movement, contrast | Children | Movement. |
| | variations. | | |
| Sport | Thin detail, | Funfair | Localised high motion. |
| | movement. | | |
| View | Slow movement, | Street | Some movement. |
| | detail. | | |

Video Test Material—Encoding all of the training and test sequences were encoded using the H.264 encoder JM7.5c with the same encoder options set for each.

Key features of the encoder settings were: I, P, B, P, B, P, . . . frame pattern; Rate Control disabled; Quantisation parameter (QP) fixed; Adaptive frame/field coding enabled; Loop-filtering disabled

With so many different possible encoder set-ups, it was decided to keep the above settings constant and to vary only the quantiser step-size parameters between tests for each source file.

Formal single-stimulus subjective tests were performed using 12 subjects for both training and testing sets. Averaged MOS results are shown in Table 5 (training set) and Table 6 (test set).

TABLE 5
Subjective scores for training sequences.

| | QP-P, QP-B | | | | | |
|---|---|---|---|---|---|---|
| Sequence | 20, 22 | 28, 30 | 32, 34 | 36, 38 | 40, 42 | 44, 46 |
| Barcelona | 4.86 | — | 4.43 | 3.29 | 2.43 | 2 |
| Harp | — | 5 | 4.43 | 3.57 | 2.14 | 1.43 |
| Canoe | 4.86 | 4.14 | 4.14 | 2.86 | 2 | — |
| Rugby | 4.86 | 4.71 | 4.71 | 2.86 | 1.86 | — |
| Calendar | 4.86 | 4.57 | — | 4 | 2.86 | 1.86 |
| Fries | 4.43 | 4.29 | 3.71 | 3.14 | 2.14 | — |
| Rocks | — | 5 | 4.43 | 4.29 | 3.71 | 2.57 |
| Sport | — | 4.43 | 4.57 | 3.57 | 2.14 | 1.29 |
| View | | 4.29 | 3.57 | 3.14 | 3.14 | 1.71 |

TABLE 6
Subjective scores for test sequences.

| | QP-P, QP-B | | | | | |
|---|---|---|---|---|---|---|
| Sequence | 14, 16 | 24, 26 | 30, 32 | 34, 36 | 38, 40 | 42, 44 |
| Boat | 4.47 | 4.47 | 4.13 | 3.4 | 2.07 | 1.27 |
| Bridge | 4.6 | 4.07 | 3.73 | 3.67 | 2.8 | 1.8 |
| Ballroom | 4.33 | 4.27 | 4.4 | 4.1 | 3.1 | 1.93 |
| Crowd | 4.47 | 4.8 | 4.4 | 3.7 | 2.2 | 1.2 |
| Animals | 4.67 | 4.67 | 4.3 | 2.6 | 1.4 | 1.13 |
| Fountain | 4.6 | 4.13 | 3.8 | 2.6 | 1.7 | 1.07 |
| Children | 4.6 | 4.73 | 4.53 | 4.07 | 3.07 | 2.2 |
| Funfair | 5 | 5 | 4.6 | 3.87 | 3.07 | 1.67 |
| Street | 4.8 | 4.67 | 4.53 | 3.73 | 2.73 | 1.87 |

Quality Estimation—Peak Signal To Noise Ratio: peak signal to noise ratio (PSNR) is a commonly used full-reference measure of quality and is a key measure for optimisations in many video encoders. With correctly aligned reference and degraded sequences, PSNR is a straightforward measure to calculate and a time-averaged measure (AvPSNR) may be calculated according to

$$AvPSNR = ( 1 / N ) {\sum }_{n = 0}^{N - 1} ( 10 {log}_{10} ( {255}^{2} * Y * X ) / ( {\sum }_{y = 0}^{Y - 1} {\sum }_{x = 0}^{X - 1} {( \begin{matrix}s ( n , x , y ) - \\ d ( n , x , y )\end{matrix} )}^{2} ) ) \qquad ( 11 )$$

where s(n,x,y) and d(n,x,y) are corresponding pixel intensity values (0.255) within the n′th frame of N from source s and degraded d sequences of dimension of X horizontal (x=0 . . . X−1) and Y vertical (y=0 . . . Y−1) pixels. This equation was used to calculate the average PSNR over the 8 seconds of each of the 9 training sequences. A plot of average PSNR against average measured MOS is shown in FIG. 11.

The content-dependent nature of the data is demonstrated when MOS scores at an average PSNR of 25 dB are considered. A 3 MOS-point range in the data shows the potential inaccuracy of using PSNR to estimate perceived quality. Polynomial regression analysis yields a correlation of 0.78 and RMS residual of 0.715 between the MOS and AvPSNR data.

Quality Estimation—Quantiser Step-size: for H.264, the quantiser parameter QP defines the spacing, QSTEP, of the linear quantiser used for encoding the transform coefficients. OP indexes a table of predefined spacings, in which QSTEP doubles in size for every increment of 6 in OP.

For each test on the training set, OP was fixed at one value of 20, 28, 32, 36, 40 or 44 for P and I macroblocks and 2 greater for B macroblocks. FIG. 12 shows a plot of average QP against average MOS for each of the 9 training sequences.

Polynomial regression analysis between MOS and average QP yields a correlation of 0.924 and RMS residual of 0.424. It is also evident that the expected MOS range at a variety of OP values is significantly less than that for AvPSNR.

One estimate of PSNR from quantiser step size relies on the approximation of a uniform distribution of error values within the quantisation range. However, this approximation does not hold for low bit-rates with large step-sizes, when the majority of coefficients are “centre-clipped” to zero. Somewhat surprisingly, the results show that AvQP may be a better predictor of subjective score than PSNR. It should be noted here, that the possibility that non-linear mapping between OP and actual quantiser step-size in H.264 might somehow ease the polynomial analysis has been discounted, with similar results achieved for actual step-size vs. MOS.

Pixel Contrast Measure—Distortion Masking: distortion masking is an important factor affecting the perception of distortion within coded video sequences. Such masking occurs because of the inability of the human perceptual mechanism to distinguish between signal and noise components within the same spectral, temporal or spatial locality. Such considerations are of great significance in the design of video encoders, where the efficient allocation of bits is essential. Research in this field has been performed in both the transform and pixel domains. Here, only the pixel domain is considered.

Pixel Contrast Measure—Pixel Difference Contrast Measure: here, the idea of determining the masking properties of image sequences by analysis in the pixel domain is applied to video quality estimation. Experiments revealed a contrast measure calculated by sliding window pixel difference analysis to perform particularly well.

Pixel difference contrast measures Cₕ and Cᵥ are calculated according to equations (2) and (3) above, where H is the window length for horizontal pixel analysis and V is the window length for vertical pixel analysis. Cₕ and Cᵥ may then be combined to give a horizontal-vertical measure Cₕᵥ, according to equation (4). Cₕᵥ may then used to calculate an overall pixel difference measure, CF, for a frame according to equation (5), and in turn a sequence-averaged measure CS, as defined in equation (6) above. The sequence-averaged measure CS (referred to as TCF above) was calculated for each of the decoded training sequences using H=4 and V=2 and the results, plotted against average quantiser step size, are shown in FIG. 13.

The results in FIG. 13 show a marked similarity in ranking to the PSNR vs. MOS results of FIG. 11 and, to a lesser degree, the AvQstep vs. MOS results of FIG. 12. The “calendar” and “rocks” sequences have the highest CS values and, over a good range of both PSNR and AvQstep, have the highest MOS values. Similarly, the “canoe” and “fries” sequences have the lowest CS values and amongst the lowest MOS values. Therefore, the CS measure calculated from the decoded pixels appears to be related to the noise masking properties of the sequences. High CS means high masking and therefore higher MOS for a given PSNR. The potential use of the CS measure in no-reference quality estimation was tested by its inclusion in the multiple regression analysis described below.

Results: firstly, average MOS (dependent variable) for the training, set was modelled by PSNR (independent variable) using standard polynomial/logarithmic regression analysis as available in many commercial statistical software packages, for example Statview™, for which see www.statview.com. The resulting model was then used on the test sequences. This was then repeated using AvQP as the independent variable. The process was repeated with CS as an additional independent variable in each case and the resulting correlation between estimated and measured MOS values and RMS residuals are shown in table 7.

TABLE 7
Correlation and RMS residual of estimated MOS with measured MOS.

| | Correlation (RMS residual) | | | |
|---|---|---|---|---|
| Sequence set | PSNR | PSNR, CS | AvQP | AvQP, CS |
| Training sequences | 0.77 (0.71) | 0.91 (0.47) | 0.92 (0.44) | 0.95 (0.33) |
| Test sequences | 0.818 (0.847) | 0.879 (0.688) | 0.875 (0.576) | 0.916 (0.486) |

Results show that including the sequence averaged contrast measure (CS) in a PSNR or AvQP-based MOS estimation model increases performance for both training and test data sets. The performance of the model using AvQP and CS parameters was particularly good, achieving a correlation of over 0.9 for both training (0.95) and more impressively testing (0.916).

The individual training and test results for the AvQP/CS model are shown in the form of a scatter plot in FIG. 14.

Conclusions: a two parameter model for the estimation of subjective video quality in H.264 video decoders has been presented. The AvQP parameter, which corresponds to the H.264 quantiser step-size index averaged over a video sequence, contributes an estimate of noise. The CS parameter, calculated using sliding-window difference analysis of the decoded pixels, adds an indication of the noise masking properties of the video content. It is shown that, when these parameters are used together, surprisingly accurate subjective quality estimation may be achieved in the decoder.

The 8-second training and test sequences were selected with a view to reducing marked variations in the image properties over time. The aim was to use decoded sequences with a consistent nature of degradation so that measured MOS scores were not unduly weighted by short-lived and distinct distortions. In this way, modelling of MOS scores with sequence-averaged parameters becomes a more sensible and accurate process.

The contrast measure CF defined in equation (5) depends on an average being performed over each pixel for the whole cropped image. It was recognised that analysing CF over spatio-temporal blocks, might be beneficial.

1.-19. (canceled)

20. A method of encoding a video signal representative of a plurality of frames, the method comprising:
(a) encoding the video signal, or part thereof, using a compression algorithm utilising at least one encoding parameter;
(h) automatically generating a quantified measure of quality for the encoded signal using a perceptual quality metric;
(c) automatically identifying whether said quantified quality measure meets a predefined quality criterion;
(d) in the event that said quality measure fails to meet the predefined quality criterion, iteratively performing steps (a) to (c) using either a modified value for the at least one encoding parameter, or a modified version of the video signal, until the quality measure so generated meets the predefined quality criterion,
wherein the type and/or amount of modification that is applied is dependent on one or more parameters generated using said perceptual quality metric.

21. A method according to claim 20, further comprising transmitting the encoded signal to a video decoder over a communications link only when the quality measure meets the predefined quality criterion.

22. A method according to claim 20 wherein, in step (c), the amount of modification applied to the encoding parameter value or the video signal is a function of the value of the quality measure generated in step (b).

23. A method according to claim 20, the method being performed in respect of first and second signal portions, the second signal portion being encoded only when the quality measure in respect of the first signal portion meets the predefined quality criterion.

24. A method according to claim 20, wherein the quality measure is a numerical value generated using a predetermined algorithm and wherein the quality measure meets the predefined quality criterion if its value is within a predefined range of values.

25. A method according to claim 24, wherein the predefined range is defined between first and second boundary values and wherein the modification applied results in a change in the quality measure value so that, in the or each subsequent iteration, it converges towards one of the boundary values.

26. A method according to claim 20, wherein the encoded signal represents a plurality of separately identifiable groups of frames (GOP), wherein a quality measure is derivable in respect of each GOF, and wherein, in step (c), a modified value for the at least one encoding parameter, or a modified version of the video signal, is applied in respect of each GOF not meeting the predetermined quality criterion.

27. A method according to claim 26, further comprising providing a plurality of modification profiles, each defining an alternative modification method to be applied in step (c), and selecting one of said profiles in dependence on one or more selection rules.

28. A method according to claim 27, wherein a first modification profile is selected in the event that a predetermined number of consecutive GOF fail to meet the predefined quality criterion, said first profile being arranged, when applied, to reencode a filtered version of the video signal corresponding to the GOF.

29. A method according to claim 28, wherein the filtering comprises reducing the number of bits required to encode each frame of the GOP.

30. A method according to claim 27, wherein a second modification profile is selected in the event that, within a segment comprising a predetermined number of GOF, only some GOP fail to meet the predefined quality criterion, said second profile being arranged, when applied, to re-encode the video signal corresponding to each failed GOF using a modified encoding parameter.

31. A method according to claim 20, wherein a further quality measure is generated for each individual frame and wherein, where said further quality measure for a frame fails to meet the predefined quality criterion, intra-frame analysis is performed on said frame to determine which part of the frame requires modification.

32. A method according to claim 20, wherein the at least one encoding parameter includes the quantization step size and wherein step (c) comprises applying a modified value of quantization step size.

33. A method according to claim 20, wherein the at least one encoding parameter includes the encoding bit rate and wherein step (C) comprises applying a modified value of the encoding bit rate.

34. A method of encoding a video signal representative of a plurality of frames, the method comprising:
(a) encoding the video signal using a compression algorithm utilising at least one encoding parameter;
(b) generating a measure of quality for the encoded signal in the form of a numerical value using a perceptual quality metric and identifying whether said numerical value meets a predefined quality criterion, said quality criterion being defined by a range of numerical values having an upper bound and a lower bound;
(c) in the event that said quality measure fails to meet the predefined quality criteirion, modifying the at least one encoding parameter and repeating steps (a) and
(d) for the video signal, said modification of the encoding parameter being such as to reduce the difference between the quality criterion and the updated quality measure.

35. A carrier medium for carrying processor code which when executed on a processor causes the processor to carry out the method of claim 20.

36. A video encoding system comprising:
a video encoder arranged to encode a video signal representative of a plurality of frames using a compression algorithm utilising at least one encoding parameter;
a controller for receiving the encoded signal from the video encoder and arranged to generate a measure of quality for the encoded signal using a perceptual quality metric, to identify whether said quality measure meets a predefined quality criterion and, in the event that said quality measure fails to meet the predefined quality criterion, to cause the video encoder to iteratively re-encode the video signal using either a modified value for the at least one encoding parameter, or a modified version of the video signal, until the quality measure so generated meets the predefined quality criterion, wherein the type and/or amount of modification that is applied is dependent on one or more parameters generated using said perceptual quality metric.

37. An IPTV service provisioning system comprising an encoding system arranged to transmit at least one channel of video data to a plurality of receivers over respective IP links, said encoding system being defined in claim 36.
